(19) United States
(12) Patent Application Publication
(10) Pub. No.: US 2026/0031288 A1
(43) Pub. Date: Jan. 29, 2026

(54) Vertical and Horizontal Switching Trigger Conduction Mechanism Applied to Key Switch

(71) Applicant: DONGGUAN CITY KAIHUA ELECTRONICS CO.LTD, Dongguan, Guangdong (CN)

(72) Inventors: Fuxi WU, Dongguan, Guangdong (CN); Panhao LV, Dongguan, Guangdong (CN)

(21) Appl. No.: 18/995,798

(22) PCT Filed: Dec. 4, 2023
(86) PCT No.: PCT/CN2023/136101

§ 371 Date: Jan. 16, 2025

(30) Foreign Application Priority Data
Dec. 13, 2022 (CN) 202223338095.7

(51) Int. Cl. H01H 13/14; H01H 13/10

(52) U.S. Cl. CPC H01H 13/14; H01H 13/10

(57) ABSTRACT

A longitudinal and transverse conversion type connection trigger mechanism applied to a key switch, the connection trigger mechanism comprising a base (1), a balance frame assembly (2) arranged on the base (1), a connection assembly (3), and a drive rod (4), which is driven by the balance frame assembly (2) and triggers the connection assembly (3) to connect and disconnect. By means of converting a longitudinal acting force into a transverse acting force when producing a pressing balance effect, the longitudinal and transverse conversion type connection trigger mechanism applied to a key switch triggers the movable piece (32) to be connected to and disconnected from the static piece (31), such that the accuracy of switch-on and -off actions and the sensitivity of the key switch when the key switch is switched on and off are improved.

### TECHNICAL FIELD

The utility model relates to the field of key switches, in particular to a vertical and horizontal conversion trigger conduction mechanism applied to key switches.

### TECHNICAL BACKGROUND

In the existing key switch, the conducting structure of the moving and static pieces is usually that the moving and static pieces are longitudinally arranged when the key cap is pressed to move up and down, and the action block on the key cap directly acts on the moving piece, and the conducting and disconnecting functions of the key switch are realized by the moving of the moving piece up and down.

At the same time, in order to improve the pressing balance, a balance frame structure is usually added inside the key switch, so that when the key cap on the key switch is pressed at any position, it can move down smoothly, thus improving the pressing balance.

However, when the balance frame structure and the conducting structure of the moving and static blades are added at the same time in the existing key switch, there is no direct linkage between the two groups of structures, and the two groups of structures play their respective roles, which may lead to the problem that the time of pressing the conducting and disconnecting actions is not synchronized with the time of pressing the balancing action, which is not conducive to improving the accuracy and sensitivity of the conducting and disconnecting actions.

### SUMMARY OF UTILITY MODEL

In view of the above shortcomings, the utility model aims to provide a vertical and horizontal conversion trigger conduction mechanism applied to a key switch, which can trigger the conduction and disconnection between the moving plate and the static plate by converting the vertical acting force into the horizontal acting force when the pressing balance function is generated, so as to realize the conduction and disconnection function of the key switch with high accuracy and improve the sensitivity of the key switch.

The technical scheme adopted by the utility model is as follows:

The invention relates to a vertical and horizontal conversion trigger conduction mechanism applied to a key switch, which comprises a base, a balance frame component arranged on the base, a conduction component, and a driving rod driven by the balance frame component and triggering the conduction component to be turned on and off, wherein, the conduction component comprises a static piece and a moving piece arranged at the side of the static piece, and is characterized in that a lateral bump is arranged on the moving piece, and the driving rod is arranged at the side of the lateral bump and used for laterally acting on the lateral bump.

As a further improvement of the utility model, a yielding inclined surface is formed at the lower part of the lateral bump.

As a further improvement of the utility model, the moving plate comprises a base block and a U-shaped elastic plate arranged on the base block, and a moving contact is arranged on the side of the U-shaped elastic plate close to the static plate; The transverse bump is connected with the U-shaped elastic sheet.

As a further improvement of the utility model, the static blade is L-shaped as a whole, and a static contact corresponding to the moving contact is arranged on the side of the static blade near the U-shaped elastic sheet.

As a further improvement of the utility model, a pressing linkage block is arranged on the driving rod, and a pressing lug located above the pressing linkage block is convexly arranged on the balance frame assembly.

As a further improvement of the utility model, a yielding opening is formed in the driving rod, and the push bump is arranged on the inner wall of the yielding opening.

As a further improvement of the utility model, a mounting seat embedded in the abdication opening is arranged on the base, an accommodating groove for embedding the conducting component is formed on the lower end face of the mounting seat, and one side of the accommodating groove is provided with an opening for pushing the bump and/or the lateral bump to move.

As a further improvement of the utility model, one end of the driving rod far away from the pressing linkage block is rotatably connected with the mounting seat.

As a further improvement of the utility model, the balance frame assembly comprises a balance frame A rotatably connected to the base, a balance frame B rotatably connected to the base and the balance frame A respectively, and a tension spring connected between the balance frame A and the balance frame B.

The utility model has the beneficial effects that: through the special installation and action modes of the base, the balance frame assembly, the driving rod, the static piece and the moving piece, when the balance frame assembly produces the pressing balance function, the longitudinal acting force is converted into the transverse acting force at the same time, so as to realize the on-off function of the key switch. Specifically, by pressing the balance frame assembly downward, the balance frame assembly provides balance and stability for the pressing of the key switch, and at the same time, the balance frame assembly transmits the longitudinal downward pressure to the driving rod, and then the pushing lug on the driving rod exerts a lateral force on the lateral lug of the moving plate, that is, the longitudinal force is converted into a lateral force, which triggers the connection and disconnection between the moving plate and the static plate, thus realizing the connection and disconnection functions of the key switch, having high accuracy of the connection and disconnection actions and improving the sensitivity of the key switch.

The above is an overview of the technical scheme of the utility model, and the following is a further explanation of the utility model with the attached drawings and specific embodiments.

### BRIEF DESCRIPTION OF DRAWINGS

FIG. 1 is an exploded view of the utility model;

FIG. 2 is a schematic diagram of the overall structure of the utility model;

FIG. 3 is a schematic structural diagram of the on-off component in the utility model;

FIG. 4 is a schematic structural diagram of the conductive component in the utility model in a conductive state;

FIG. 5 is a schematic structural diagram of the utility model in which the rotor is arranged at the bottom of the base;

FIG. 6 is a structural schematic diagram of the conduction component arranged at the bottom of the base in the utility model.

### EMBODIMENT

In order to further explain the technical means and effects adopted by the utility model to achieve the predetermined purpose, the specific implementation of the utility model will be described in detail with the attached drawings and preferred embodiments.

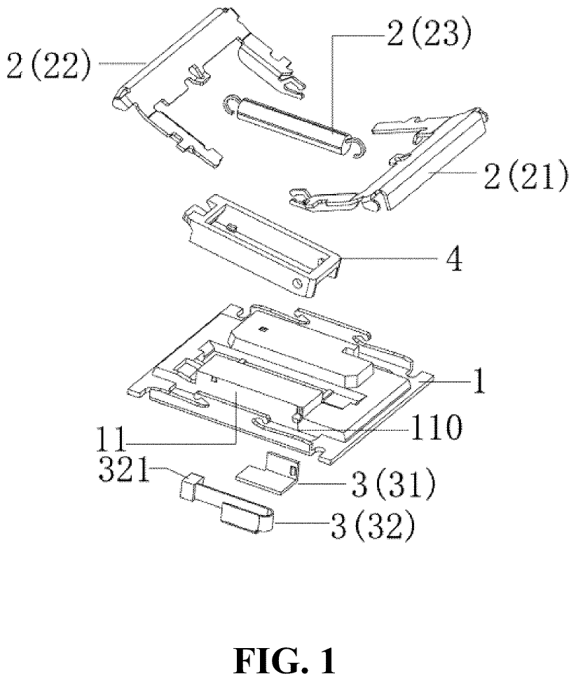

Please refer to FIG. 1 to FIG. 3. An embodiment of the utility model provides a vertical and horizontal switching trigger conduction mechanism for a key switch, which comprises a base 1, a balance frame assembly 2, a conduction assembly 3 and a driving rod 4 driven by the balance frame assembly 2 and triggering the conduction assembly 3 to turn on and off. The conducting assembly 3 includes a stationary piece 31 and a moving piece 32 arranged at the side of the stationary piece 31, and a lateral bump 321 is arranged on the moving piece 32, and a pushing bump 41 located at the side of the lateral bump 321 is arranged on the driving rod 4 for laterally acting on the lateral bump 321.

By pressing the balance frame assembly 2 down, the balance frame assembly 2 provides balance and stability for the pressing of the key switch, and at the same time, the balance frame assembly 2 transmits the longitudinal downward pressure to the driving rod 4, and then the pushing projection 41 on the driving rod 4 exerts a lateral force on the lateral projection 321 of the moving plate 32, that is, when the balance frame assembly 2 produces the pressing balance, the longitudinal force is converted into a lateral force to trigger the connection and disconnection between the moving plate 32 and the stationary plate 31, so as to realize the connection and disconnection of the key switch.

In this embodiment, as shown in FIG. 3, the moving piece 32 includes a base block 321 and a U-shaped elastic piece 322 arranged on the base block 321, and a moving contact 3221 is arranged on the side of the U-shaped elastic piece 322 close to the stationary piece 31; The lateral projection 321 is connected to the U-shaped elastic sheet 322. The stator 31 is L-shaped as a whole, and a stationary contact 311 corresponding to the moving contact 3221 is arranged on the side of the stator 31 near the U-shaped elastic sheet 322.

At the same time, in order to cooperate with the realization of pressing on and off functions, as shown in FIG. 5, a yielding inclined surface 322 is formed at the lower part of the lateral projection 321.

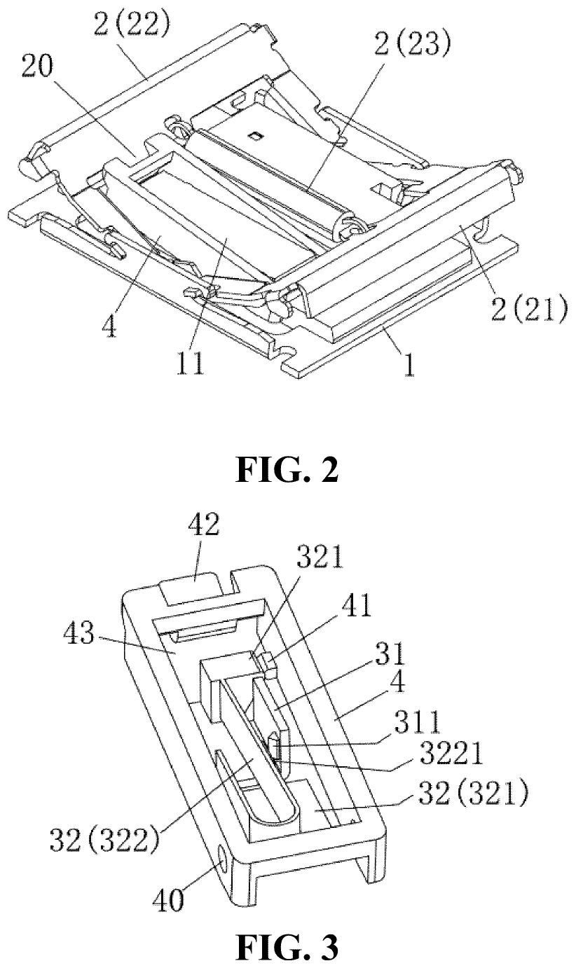

In this embodiment, as shown in FIG. 2 and FIG. 3, the driving rod 4 is provided with a pressing linkage block 42, and the balance frame assembly 2 is convexly provided with a pressing lug 20 located above the pressing linkage block 42.

As shown in FIG. 3, when the balance frame assembly 2 is in a natural unpressurized state, the push projection 41 pushes the lateral projection 321 to the side, so that the U-shaped elastic piece 322 of the moving plate 32 is elastically deformed away from the static plate 31, so that the moving contact point 3221 on the moving plate 32 is separated from the static contact point 311 on the static plate 31. At this time, the conductive assembly 3 is in an off state, and the off function of the key switch is realized.

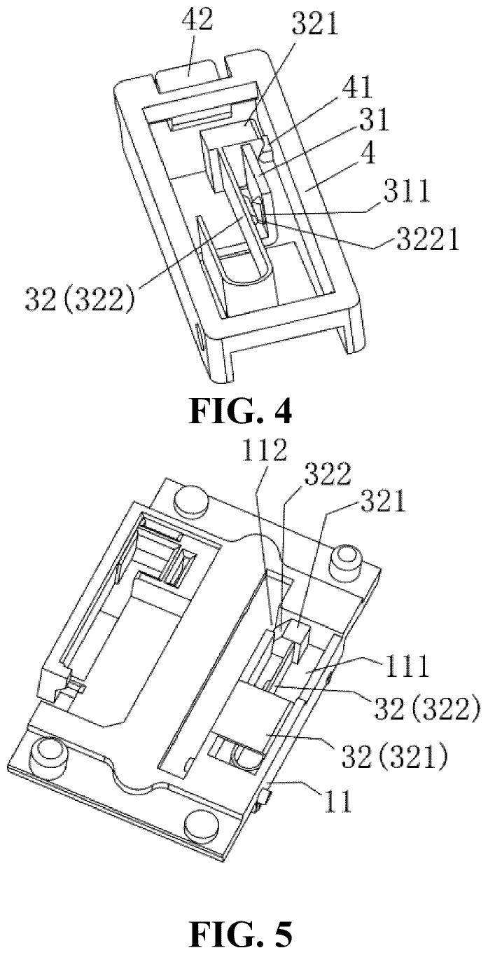

When the press balance frame assembly 2 moves down, the longitudinal downward pressure is transmitted by the press projection 20 to the press linkage block 42 on the drive rod 4, and the press linkage block 42 drives the drive rod 4 to move down, so that the push projection 41 on the drive rod 4 moves down until it meets the yielding inclined surface 322 at the lower part of the lateral projection 321, as shown in FIG. 4, so that the force exerted by the push projection 41 on the lateral projection 321 gradually disappears. Finally, under the elastic restoring force of the U-shaped elastic piece 322 of the moving piece 32, the U-shaped elastic piece 322 drives the transverse bump 321 to move backward and reset, so that the moving contact 3221 on the moving piece 32 contacts the stationary contact 311 on the stationary piece 31, and then the conducting assembly 3 is in a conducting state, thus realizing the conducting function of the key switch.

When the downward pressure on the balance frame assembly 2 disappears, under the elastic restoring force of the tension spring 23 in the balance frame assembly 2 described below, the balance frame assembly 2 moves upward and resets as a whole, and the pressing lug 20 drives the pressing linkage block 42 and the driving rod 4 to move upward and reset as a whole, so that the pushing lug 41 on the driving rod 4 moves upward and exerts a lateral force on the lateral lug 321 again, so that the U-shaped elastic piece 322 of the moving plate 32 elastically deforms and moves away from the stationary plate 31. Such that the moving contact 3221 on the moving plate 32 is separated from the stationary contact 311 on the stationary plate 31, as shown in FIG. 3, the conducting assembly 3 is restored to the off state, and the off function of the key switch is realized.

Therefore, by converting the longitudinal acting force into the transverse acting force, the connection and disconnection between the movable piece 32 and the stationary piece 31 are triggered, so that the connection and disconnection functions of the key switch are realized, the accuracy of the connection and disconnection actions is high, and the sensitivity of the key switch is improved.

In order to cooperate with the installation of the moving piece 32 and the stationary piece 31, as shown in FIG. 3, a yielding opening 43 is formed in the driving rod 4, and the pushing projection 41 is arranged on the inner wall of the yielding opening 43.

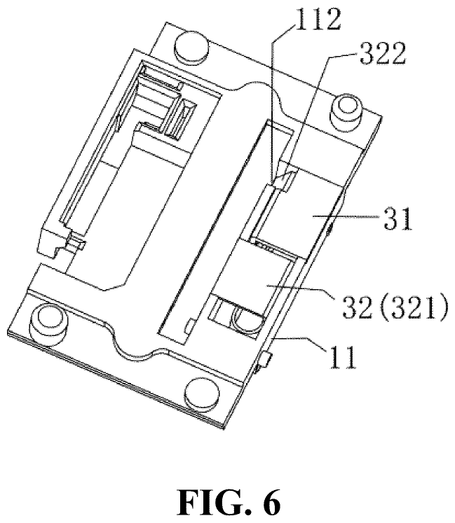

Meanwhile, as shown in FIG. 2, FIG. 5 and FIG. 6, a mounting seat 11 embedded in the yielding opening 43 is arranged on the base 1, and an accommodating groove 111 for embedding the conducting component 3 is formed on the lower end surface of the mounting seat 11. One side of the receiving groove 111 is provided with a side opening 112 for pushing the projection 41 and/or the lateral projection 321 to move, so as to facilitate the lateral movement of the projection 41 to act on the lateral projection 321, and also facilitate the lateral movement of the lateral projection 321 when stressed, and to improve the accuracy of the on-off action of the conducting assembly 3.

In this embodiment, the end of the driving rod 4 far away from the pressing linkage block 42 is rotatably connected with the mounting seat 11. Specifically, as shown in FIG. 1, two sides of the mounting base 11 are provided with rotating shafts 10, and the driving rod 4 is provided with mounting holes 40 into which the rotating shafts 110 are inserted. As shown in FIG. 3, the driving rod 4 can rotate along the rotating shafts 110. Therefore, when the driving rod 4 is driven by the balance frame assembly 2 to move up and down, only one end close to the pressing linkage block 42 moves up and down, so that the driving rod 4 moves up and down by swinging, and the action stability of the driving rod 4 is improved.

In this embodiment, as shown in FIG. 1, the balance frame assembly 2 includes a balance frame A21 rotatably connected to the base 1, a balance frame B 22 rotatably connected to the base 1 and the balance frame A 21 respectively, and a tension spring 23 connected between the balance frame A 21 and the balance frame B 22. The balance frame assembly 2 provides balance and stability for pressing the key switch, and at the same time, the tension spring 23 provides elastic restoring force for pressing and resetting. In specific use, a key cap is installed on the balance frame A 21 and the balance frame B 22. The specific structure of the balance frame A 21 and the balance frame B 22, and the installation mode of the key cap are not the innovation points of this utility model. For the specific structure, please refer to the utility model patent with the patent number of 202121092814.4 and the patent name is “a photoelectric key switch for increasing the pressing feel”, which is not repeated here.

The above is only the preferred embodiment of this utility model, and it does not limit the technical scope of this utility model. Therefore, other structures obtained by adopting the same or similar technical features as the above embodiments of this utility model are within the protection scope of this utility model.

What is claimed is:

1. The invention relates to a vertical and horizontal conversion trigger conduction mechanism applied to a key switch, which comprises a base, a balance frame component arranged on the base, a conduction component, and a driving rod driven by the balance frame component and triggering the conduction component to be turned on and off. Wherein, the conducting component comprises a static piece and a moving piece arranged at the side of the static piece, and is characterized in that a transverse bump is arranged on the moving piece, and a pushing bump which is positioned at the side of the transverse bump and is used for transversely acting on the transverse bump is arranged on the driving rod.

2. According to claim 1, the vertical and horizontal switching trigger conduction mechanism applied to the key switch is characterized in that a yielding inclined surface is formed at the lower part of the lateral bump.

3. According to claim 1, the vertical and horizontal switching trigger conduction mechanism applied to the key switch is characterized in that the moving piece comprises a base block and a U-shaped elastic piece arranged on the base block, and a moving contact is arranged on the side surface of the U-shaped elastic piece close to the static piece; The transverse bump is connected with the U-shaped elastic sheet.

4. According to claim 3, the vertical and horizontal switching trigger conduction mechanism applied to the key switch is characterized in that the static piece is L-shaped as a whole, and a static contact corresponding to the moving contact is arranged on the side of the static piece close to the U-shaped elastic piece.

5. According to claim 1, the vertical and horizontal switching trigger conduction mechanism applied to the key switch is characterized in that a pressing linkage block is arranged on the driving rod, and a pressing lug located above the pressing linkage block is convexly arranged on the balance frame assembly.

6. According to claim 5, the vertical and horizontal switching trigger conduction mechanism applied to the key switch is characterized in that a yielding opening is formed in the driving rod, and the pushing bump is arranged on the inner wall of the yielding opening.

7. According to claim 6, the vertical and horizontal switching trigger conduction mechanism applied to a key switch is characterized in that a mounting seat embedded in a yielding opening is arranged on the base, an accommodating groove for embedding conduction components is formed on the lower end face of the mounting seat, and one side of the accommodating groove is provided with an opening for pushing the bump and/or the lateral bump to move.

8. According to claim 7, the vertical and horizontal switching trigger conduction mechanism applied to the key switch is characterized in that one end of the driving rod far away from the pressing linkage block is rotatably connected with the mounting seat.

9. According to claim 1, the vertical and horizontal switching trigger conduction mechanism applied to the key switch is characterized in that the balance frame assembly comprises a balance frame A rotatably connected to the base, a balance frame B rotatably connected to the base and the balance frame A respectively, and a tension spring connected between the balance frame A and the balance frame B.
